(19) United States
(12) Patent Application Publication
(10) Pub. No.: US 2016/0196568 A1
(43) Pub. Date: Jul. 7, 2016

(54) METHOD AND SYSTEM FOR PROVIDING PROMOTION PLATFORM FOR MOBILE APPLICATION

(71) Applicant: NHN Entertainment Corporation, Seongnam-si (KR)

(72) Inventor: Eun Young SONG, Seongnam-si (KR)

(21) Appl. No.: 14/789,461

(22) Filed: Jul. 1, 2015

(30) Foreign Application Priority Data
Jan. 7, 2015 (KR) 10-2015-0002054

(51) Int. Cl. G06Q 30/02

(52) U.S. Cl. CPC G06Q 30/0209; G06Q 30/0267

(57) ABSTRACT

Provided is a method and system for providing a promotion platform of a mobile application, the method including registering mobile applications, and providing a compensation corresponding to a user entry to a service provider of a first application in response to a user entering a promotion platform through a user interface provided from the first application, wherein the user having entered the promotion platform through the user interface provided from the first application receives, from a second application, the compensation in response to performing an operation designated in a promotion of the second application displayed through the promotion platform.

### CROSS-REFERENCE TO RELATED APPLICATION

This application claims priority from and the benefit of Korean Patent Application

No. 10-2015-0002054, filed on Jan. 07, 2015, which is hereby incorporated by reference for all purposes as if fully set forth herein.

### BACKGROUND

1. Field

Exemplary embodiments relate to a promotion platform providing a method and system that may support promotions of different mobile applications.

2. Discussion of the Background

Over 100 mobile applications (mobile Apps) are released and tens of or hundreds of applications (Apps) are registered to an application store (Appstore) daily. Irrespective of the release of many new mobile Apps in the market, users generally utilize Apps that they frequently use. Accordingly, new Apps may require promotion to gain users' attention. However, relatively high marketing costs are required and a promotion of a new App to an affiliated mobile App may only have a temporary effect.

For example, promotion of a new game App is generally implemented with respect to existing game Apps having secured users using a cross game promotion (CGP). In this example, users may play the new game App temporarily during a promotion period only using the CGP, and leave the new game App after the promotion period. Further, a service provider of the new game App looking for a counter party game for the CGP may also have difficulty in negotiating a schedule or a condition due to different opinions with a service provider of an existing game App.

### SUMMARY

Exemplary embodiments provide a promotion platform providing method and system that may provide a space in which different mobile Apps may gather to share traffic of users of the mobile Apps and to be mutually advertised.

Exemplary embodiments provide a promotion platform providing method and system that may attract a new user through Apps registered to a promotion platform and may enable an idle user to return.

Exemplary embodiments provide a promotion platform providing method and system that may attract a continuous user instead of a temporary user by providing a compensation to a user having performed a mission in an App of which a promotion and an advertisement are ongoing through a promotion platform and by inducing the user to continuously use the App.

Additional features of the invention will be set forth in the description which follows, and in part will be apparent from the description, or may be learned by practice of the invention.

Exemplary embodiments disclose a method of providing a promotion platform, the method including registering mobile applications to a promotion platform system; and providing a compensation corresponding to a user entry to a service provider of a first application in response to a user entering a promotion platform through a user interface of the first application, wherein the user having entered the promotion platform receives, from a second application, the compensation in response to performing an operation designated in a promotion of the second application displayed by the promotion platform.

Exemplary embodiments disclose a promotion platform system including an application register configured to register mobile applications on the promotion platform system; and a service provider configured to provide a compensation corresponding to a user entry to a service provider of a first application in response to a user entering a promotion platform through a user interface provided from the first application, wherein the user having entered the promotion platform through the user interface receives, from a second application, the compensation in response to performing an operation designated in a promotion of the second application displayed by the promotion platform.

Exemplary embodiments of the present invention also disclose a promotion platform system including a memory to which a program is loaded; and a processor, wherein, according to a control of the program, the processor is configured to process: a process of registering mobile applications; and a process of providing a compensation corresponding to a user entry to a service provider of a first application in response to a user entering a promotion platform through a user interface provided from the first application, wherein the user having entered the promotion platform through the user interface receives, from a second application, a compensation in response to performing an operation designated in a promotion of the second application displayed through the promotion platform.

Exemplary embodiments of the present invention also disclose a method of providing a promotion platform, the method including allowing a user of a first application to enter a promotion platform through the first application registered to the promotion platform;

displaying a target application to the user by the promotion platform; providing a promotion of the target application in response to a user input; and providing a compensation in response to the user performing an operation designated in the promotion, wherein the promotion platform provides the compensation corresponding to the user entry in the promotion platform through a service provider of the first application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an example of sharing traffic of users of different applications in a promotion platform system according to one or more exemplary embodiments.

FIG. 2 is a diagram illustrating a user terminal, a mobile application, and a promotion platform system according to one or more exemplary embodiments.

FIG. 3 is a block diagram illustrating a configuration of a promotion platform system according to one or more exemplary embodiments.

FIG. 4 is a flowchart illustrating a method of providing a promotion platform according to one or more exemplary embodiments.

FIG. 5 illustrates an example of a registration screen on which a mobile App participates in a promotion platform as an inventory App according to one or more exemplary embodiments.

FIG. 6 illustrates an example of a registration screen on which a mobile App participates in a promotion platform as a target App according to one or more exemplary embodiments.

FIG. 7 illustrates an example of a screen on which a mobile App registered to a promotion platform provides a platform icon according to one or more exemplary embodiments.

FIG. 8 illustrates an example of an App advertisement screen displayed to a user in response to a user entry in a promotion platform through an App in execution according to one or more exemplary embodiments.

FIG. 9 is a block diagram illustrating an example of a configuration of a computer system according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of components, etc., may be exaggerated for clarity and descriptive purposes. Also, like reference numerals denote like elements.

When a component is referred to as being “on,” “connected to,” or “coupled to” another component, it may be directly on, connected to, or coupled to the other component or intervening components may be present. When, however, a component is referred to as being “directly on,” “directly connected to,” or “directly coupled to” another component, there are no intervening components present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various features, these features should not be limited by these terms. These terms are used to distinguish one feature from another. Thus, a first feature could be termed a second feature without departing from the teachings of the present disclosure.

Spatially relative terms, such as “beneath,” “below,” “lower,” “above,” “upper,” and the like, may be used herein for descriptive purposes, and, thereby, to describe one feature's relationship to another feature as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments will be described in detail with reference to the accompanying drawings.

Exemplary embodiments may be applicable to a mobile platform system for mobile App marketing. For example, exemplary embodiments may be applicable to a field such as a mobile marketing service that collects game Apps and performs a promotion and an advertisement of a target game in each App. In addition to the game Apps, exemplary embodiments may be applicable to any type of mobile platform that collects a variety of mobiles Apps such as, for example, a map related App and a webtoon related App, and may perform an App advertisement through the collected Apps.

The terms “application” and “App” may be interchangeably used throughout.

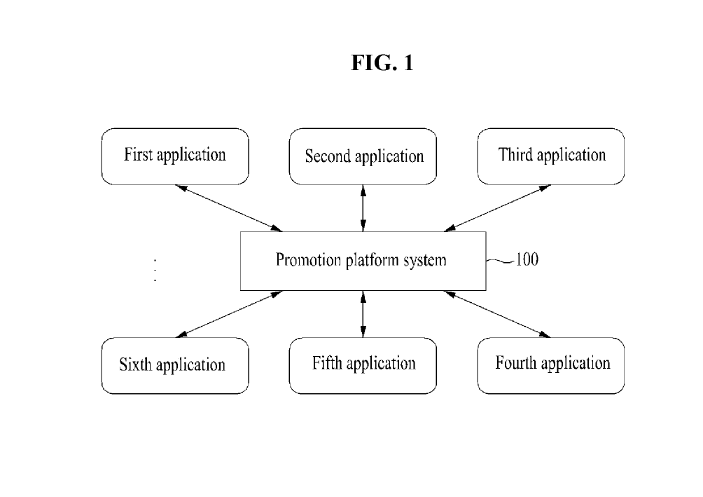

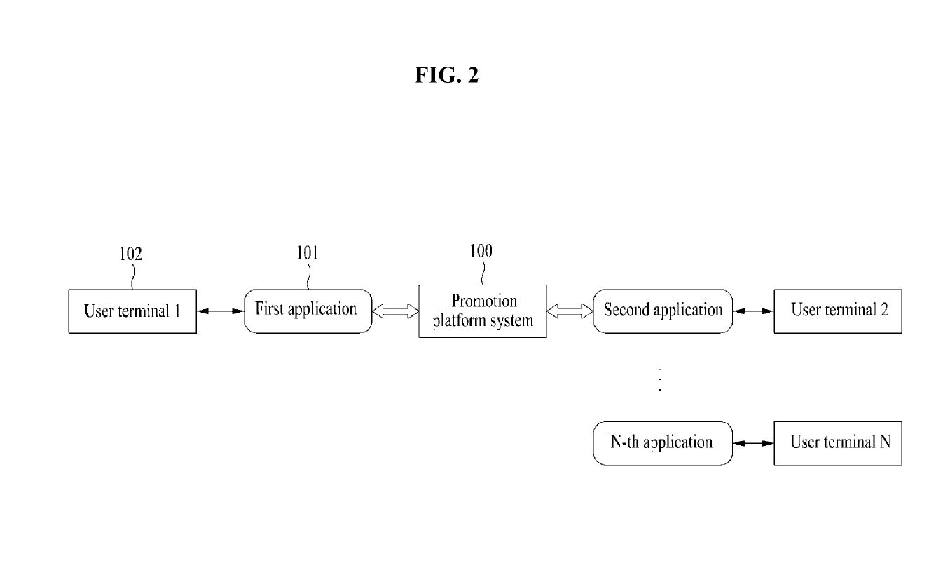

FIG. 1 is a diagram illustrating an example of sharing user traffic of different applications in a promotion platform system according to one or more exemplary embodiments, and FIG. 2 is a diagram illustrating a user terminal, a mobile application, and a promotion platform system according to one or more exemplary embodiments. Referring to FIGS. 1 and 2, a mobile application may be installed in a user terminal (not shown), and a user interface may be provided between the user terminal and the promotion platform system 100 through the installed mobile application. In FIGS. 1 and 2, indicators with arrowheads may indicate that data may be transmitted and received between the promotion platform system 100 and the user terminal over a network.

Referring to FIG. 1, promotion platform system 100 refers to a system that provides a mobile promotion/advertisement platform to share a user between mobile applications using analytics, and may register different mobile applications and thereby gather the different mobile applications. For example, each of the N number of different mobile game Apps may be registered to promotion platform system 100 for marketing such as promotion and advertisement, and may share user traffic of the N number of game Apps registered to promotion platform system 100. Each of game Apps registered to promotion platform system 100 may participate as an inventory game and concurrently display its promotion and advertisement through a promotion platform as a target game.

Promotion platform system 100 may provide compensation capable of performing marketing such as a promotion and an advertisement with respect to a user of another App to a service provider of an application having a user entry in the promotion platform. Referring to FIG. 2, when user terminal (1) 102 enters promotion platform system 100 through first application 101, promotion platform system 100 may display a promotion and an advertisement associated with first application 101 through the promotion platform. First application 101 may be advertised to at least a user of one of the N number of applications registered to the promotion platform system 100.

Although FIG. 2 illustrates that each of N applications is installed and executed in a single user terminal, aspects of the invention are not limited thereto, and thus, each application may be installed and executed in one or more user terminals. For example, a first application may be installed in user terminals 1 and 3, a second application may be installed in user terminals 1, 2, and N, and an N-th application may be installed in user terminals 2, (N−1), and N.

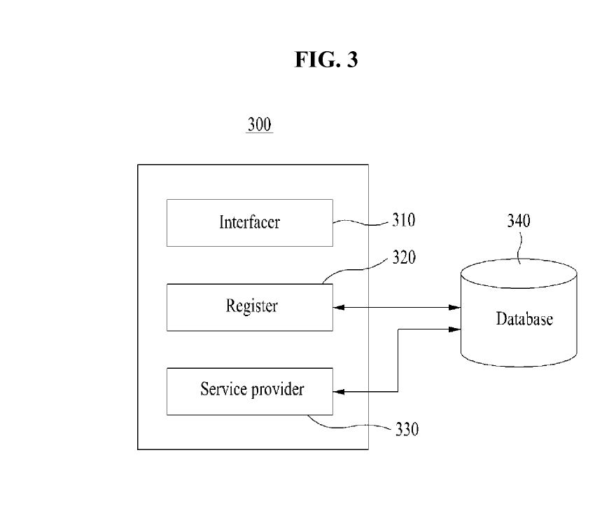

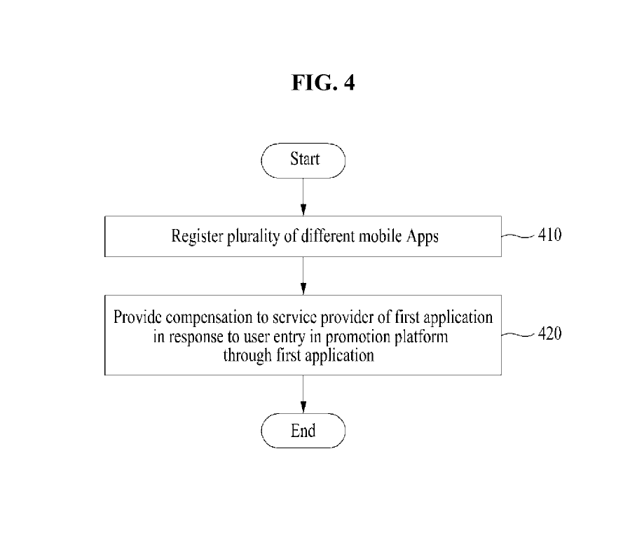

FIG. 3 is a block diagram illustrating a configuration of a promotion platform system according to one or more exemplary embodiments, and FIG. 4 is a flowchart illustrating a method of providing a promotion platform according to one or more exemplary embodiments.

Referring to FIG. 3, an interfacer 310, register 320, service provider 330, and database 340 may be configured to perform operations 410 and 420 of FIG. 4. Promotion platform system 300 refers to a system to provide a mobile platform that may perform an App advertisement using a mobile App, and may configure an infrastructure as necessary and may construct an infrastructure required for mobile App advertisement, App registration, and compensation. Promotion platform system 300 may include the interfacer 310, register 320, service provider 330, and database 340.

Interfacer 310 may provide a website for providing a service provider interface to a service provider of a mobile App. For example, interfacer 310 may provide a website for receiving information for a registration to a service provider of a mobile application that is to be registered to promotion platform system 300.

In operation 410, register 320 may register different mobile Apps through the provided website. For example, a service provider of a mobile App that is to be registered to a promotion platform through the website provided from the interfacer 310 may register an App of the service provider to the promotion platform. A registration process may include a process of inputting registration information of the mobile App participating as an inventory App and a process of inputting registration information of the mobile App participating as a target App.

The inventory App may serve to allow a user registered to the inventory App to enter the promotion platform. When participating as an inventory App, a service provider of the inventory App may input, through the website, compensation information to be provided from the inventory App to the user when the user enters the promotion platform, and information about a country in which a corresponding App is to be displayed. For example, the service provider of the inventory App may input at least one country as a target country in which a mobile App, for example, a game App, is to be released. When the game App is to be released in 20 countries, the 20 countries may be input as target countries and only 10 countries among the 20 countries may also be input as target countries. A platform icon may be displayed on the game App of the input target countries.

A target App may indicate an App to be displayed as an advertisement through a promotion platform to a user having entered the promotion platform through the inventory App. For example, the target App may include all of an App of a service provider that desires to only advertise the App of the service provider through the promotion platform without registering the App as an inventory App and an App to be advertised through the promotion platform among Apps registered as inventory Apps. When participating as the target App, a service provider of the target App may input promotion and advertisement content of the target App, a promotion and advertisement period of the target App, compensation information according to a user performing a mission associated with a promotion of the target App, and information about a target country in which the target App is to be advertised.

By using the promotion platform, a single mobile App may be an inventory App and at the same time a target App. Accordingly, a service provider of the mobile App may input all registration information to participate as the inventory App and registration information to participate as the target App through an input screen provided from the website.

Register 320 may store and manage registration information input through the input screen in database 340. Database 340 may be included in a storage media within promotion platform system 300, and may be connected to promotion platform system 300 through a network as a server independent from promotion platform system 300.

When the service provider of the mobile App completes an App registration, interfacer 310 may provide an image associated with a platform icon to the mobile App. For example, interfacer 310 may provide an image associated with a brand identity (BI) logo of a platform to the mobile App. In this case, the mobile App may register the platform icon. The BI logo of the platform may be registered as the platform icon alone, or may be registered as the platform icon through a combination with a display icon being used in the mobile App. For example, when using a game App, the game App may be displayed on a game screen by combining a display icon such as a gift box image and a jewelry image being used in a game with the BI logo of the platform.

When executing the mobile App in the user terminal, the platform icon may be displayed on an initial execution screen or an execution screen. For example, the platform icon may be displayed at an appropriate location on a game screen while moving within the game screen not to interrupt a game according to the progress of the game. In addition, the platform icon may be displayed in a fixed manner on a predetermined area such as, for example, at an upper end, at a lower end, on the left, and on the right of the game screen. In response to a user executing the game App and clicking on the platform icon, the user may enter the promotion platform.

In operation 420, service provider 330 may provide compensation to a service provider of a mobile App having the user entry in the promotion platform among different mobile Apps registered to the promotion platform. For example, when a user playing a game 1 by executing a game App 1 clicks on a platform icon on a screen of the game 1 and enters a promotion platform, service provider 330 may provide a compensation capable of displaying a promotion and an advertisement of the game App 1 to users of another App through the promotion platform.

A compensation associated with the mobile App being executed by the user may be provided to the user who has entered the promotion platform. For example, when the game App 1 promises to provide a compensation such as an item associated with the game 1 or game money in response to a click on the platform icon, the game App 1 may provide the promised compensation, for example, a game item, game money, and an e-coupon, to a user having entered the promotion platform through a user interface of the game App 1.

The user may verify a promotion and an advertisement of each mobile App displayed through the promotion platform. When one of the displayed promotion and advertisement is selected by the user and the user performs a mission associated with the selected promotion, the selected mobile App may provide compensation associated with the mobile App to the user. For example, when a promotion of a game App 2 is displayed on the promotion platform and promotion content of the game App 2 is related to promising to provide game money for member join, when the user having entered the promotion platform through the game App 1 joins the game App 2, the game App 2 may provide the promised game money to the user.

A mission associated with a promotion of a mobile App may vary such as, for example, installing a program of the corresponding App, and viewing a moving picture, a member join, a survey, or a follow. Compensation provided according to a mission completion may also vary such as, for example, game money, a game item, and an e-coupon in the completed mission App.

Examples in which the game App 1 having the user entry in the promotion platform provides a compensation to the user and the game App 2 provides a compensation according to the user having completed a mission of the game App 2 is described with reference to FIG. 4. The promotion platform may also provide compensation to the user. For example, service provider 330 may provide compensation such as game money of the game App 1, promised by the game App 1, to a user having entered the promotion platform by controlling the game App 1. Similarly, service provider 330 may provide compensation such as game money of the game App 2, promised by the game App 2, to a user having completed a mission of the game App 2 by controlling the game App 2.

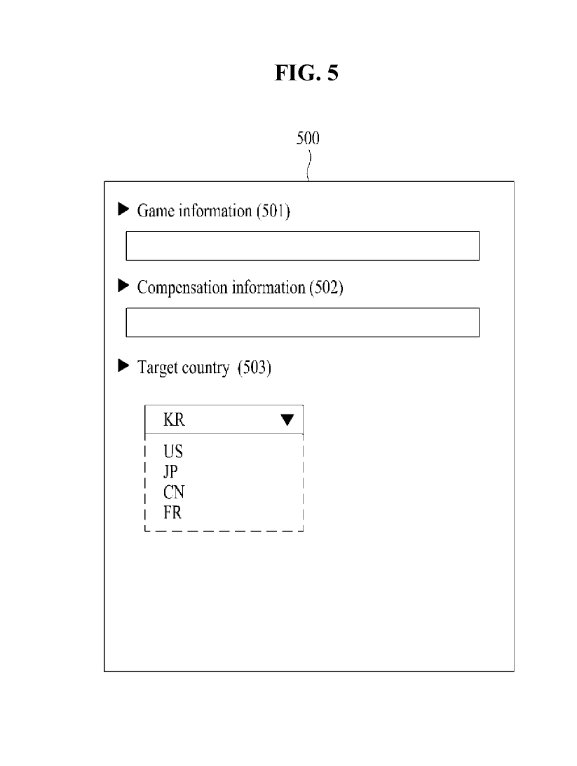

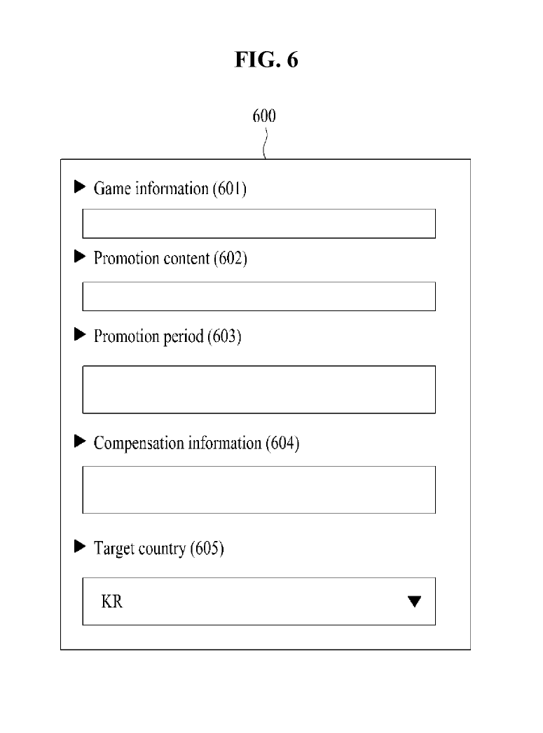

FIG. 5 illustrates an example of a registration screen on which a mobile App participates in a promotion platform as an inventory App according to one or more exemplary embodiments, and FIG. 6 illustrates an example of a registration screen on which a mobile App participates in a promotion platform as a target App according to one or more exemplary embodiments.

Referring to FIG. 5, a service provider of a mobile App may input required information when participating as an inventory App through a website provided from promotion platform system 300.

For example, when registering a game App to promotion platform system 300, a service provider of the game App may input information required for the game App to operate as an inventory App through inventory App registration screen 500. For example, the service provider of the game App may input game information 501 such as a game name and a game type, compensation information 502 to be provided to a user in response to a user entry in a promotion platform, and target country information 503. Target country information 503 may indicate a country in which users of the game App are to display a platform icon among countries connected to the game App. For example, any one country may be input as a default, and a plurality of countries, for example, 20 countries may be input. When a service provider of the game App inputs information required to participate as the inventory App and pushes a save button, the input information may be stored in database 340.

When the information required to participate as the inventory App is input, the service provider of the mobile App may input information required to participate as a target App through a website provided from promotion platform system 300 as illustrated in FIG. 6.

For example, when registering a game App to the promotion platform system 300, a service provider of the game App may input game information 601, promotion and advertisement information, compensation information 604, and target country information 605. The promotion information may include promotion content 602 and a promotion period 603. For example, the service provider of the game App may input the promotion content 602 such as installing a program of the game App, a member join, or a follow. Similarly, the advertisement information may also include advertisement content introducing the game App and an advertisement period. The compensation information 604 may include compensation content, for example, game money and a game item to be provided to the user having completed a mission associated with the input promotion content 602 such as installing the program of the game App.

The target country may indicate a county in which the target App is to be advertised. For example, the service provider of the target App may desire to advertise an App of the service provider in a country in which many users are using the mobile App, to increase an advertising effect.

When a corresponding App is an inventory App and at the same time a target App, the target App may be advertised free of charge through the promotion platform as a compensation for the user entry in the promotion platform through its own App. For example, when a single user enters the promotion platform, service provider 330 may display the target App to a single user of another App. Accordingly, when the service provider of the target App inputs a target country, and in this instance, when the service provider registers the corresponding App as the target App instead of registering the App as an inventory App, which is similar to a case in which the corresponding App is registered as both the inventory App and the target App, service provider 330 may display the target App based on the target country input through target App registration screen 600.

Referring to FIGS. 5 and 6, when a mobile App is registered to promotion platform system 300 through inventory App registration screen 500 and target App registration screen 600, promotion platform system 300 may provide an image associated with a BI logo of the promotion platform to the registered mobile App. To allow a user to enter the promotion platform and to display a promotion and an advertisement, the service provider may download an analytics software development kit (SDK) and may install the downloaded analytics SDK in the registered mobile App. The mobile App in which the analytics SDK is installed may be distributed to users through an Appstore and/or a market.

In this instance, before the mobile App is distributed to the Appstore, a test for verifying whether a promotion is accurately operating in the mobile App may be performed. For example, a test terminal may download the mobile App and may test the mobile App regarding whether the promotion is accurately displayed. Once the test is completed, the mobile App may be distributed.

An exemplary embodiment in which the mobile App participate as both the inventory App and the target App is described above with reference to FIGS. 5 and 6. The mobile App may also participate in the promotion platform as one of the inventory App and the target App.

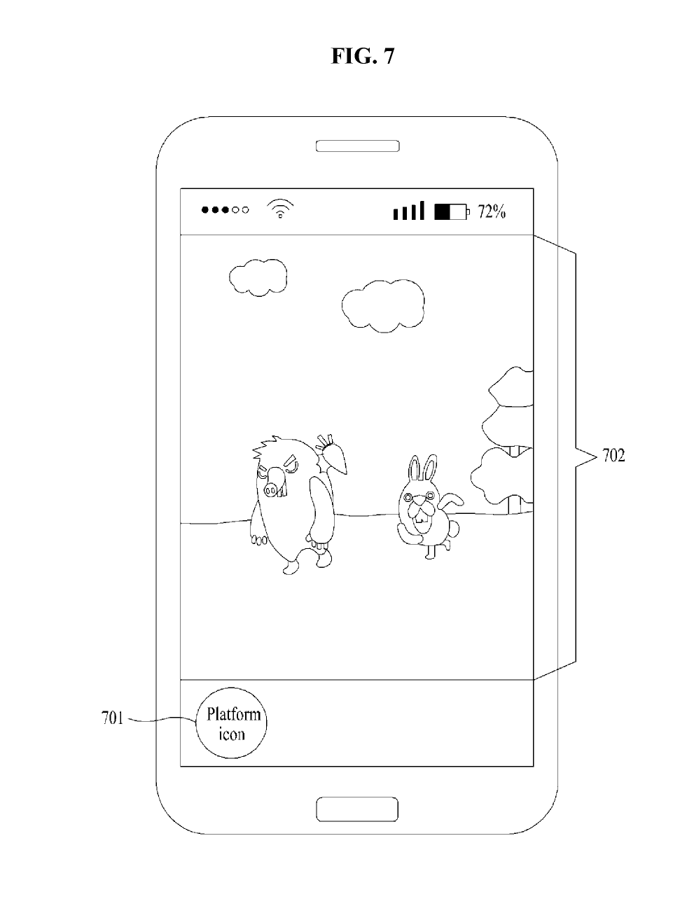

FIG. 7 illustrates an example of a screen on which a mobile App registered to a promotion platform provides a platform icon according to one or more exemplary embodiments.

In FIG. 7, it is assumed that a game App is registered to a promotion platform. In addition to the game App, various types of Apps such as, for example, a map and a webtoon may be registered to the promotion platform.

When the game App is registered to the promotion platform and an analytics SDK is installed in the game App, platform icon 701 to enter the promotion platform may be displayed on a user terminal executing the game App. Platform icon 701 may include an image associated with a BI logo of the promotion platform and may be displayed, for example, at an upper end, at a lower end, on the left, or on the right of a game screen in a feed form. Platform icon 701 may be displayed on an area that does not interrupt the user from playing a game.

For example, platform icon 701 may be displayed in a translucent form at a lower end of the game screen, or displayed in a popup window while executing and loading the game. Platform icon 701 may also, for example, be displayed in a popup window form during a loading time and may be displayed at a location fixed on a portion of the game screen or while changing a display location not to interrupt the user from playing the game.

Here, when the user selects platform icon 701, the user may enter the promotion platform through the game App. When the user enters the promotion platform through the game App, service provider 330 may count the number of users having entered the promotion platform through the corresponding App and may display a promotion and an advertisement of the corresponding App based on a count result. For example, when 10 users have entered the promotion platform through the game App, service provider 330 may display the promotion and the advertisement of the game App to ten users having entered the promotion platform through another App.

In this example, when the user does not want to display platform icon 701 and selects a stop button, platform icon 701 may not be displayed on the game screen.

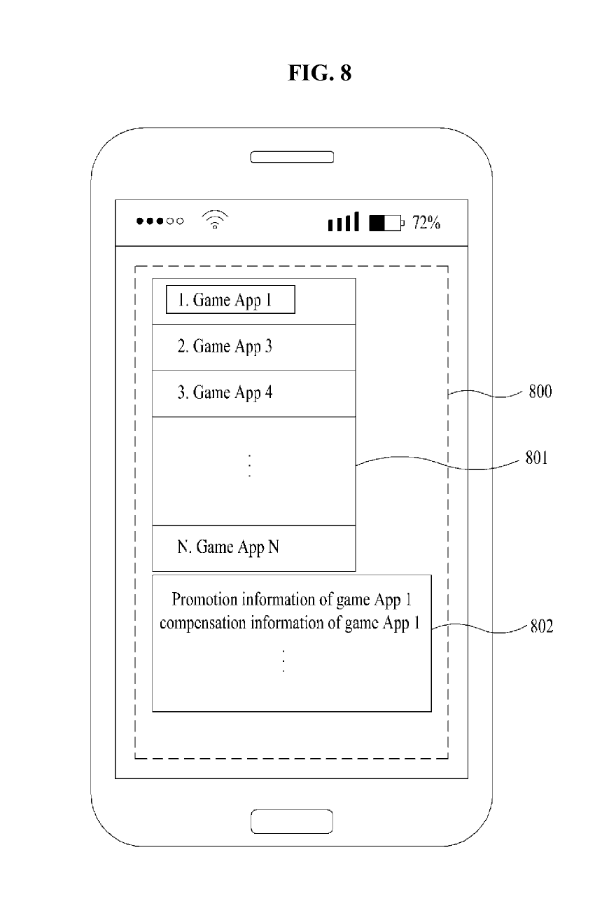

FIG. 8 illustrates an example of an App advertisement screen displayed to a user in response to a user entry in a promotion platform through an App in execution according to one or more exemplary embodiments. In FIG. 8, a description will be made based on an example of an App advertisement screen displayed to a user in response to the user having entered a promotion platform through a game App 2. Also, in FIG. 8, a description will be made based on an example in which the game App 2 is deleted from an App advertisement list in response to the user entry in the promotion platform through the game App 2. However, these are only examples and aspects of the invention are not limited thereto. For example, a promotion and an advertisement of the game App 2 may also be displayed on an App advertisement list so that the user having entered the promotion platform through the game App 2 may verify promotion information of the game App 2.

When a game App is registered to the promotion platform, service provider 330 may generate App advertisement list 801 to display promotions and advertisements of target Apps based on registration information of registered game Apps, for example, game App 1 through game App N registered as target Apps. When a user enters the promotion platform through game App 2, App advertisement screen 800 may be displayed to the user, for example, on a user terminal of the user. App advertisement screen 800 may include a screen for displaying App advertisement list 801 including a plurality of registered target Apps and a screen for displaying promotion information and compensation information 802 of a target App selected by the user from among the target Apps displayed on App advertisement list 801. When relatively many target Apps are included in App advertisement list 801, a scrolling interface may be created for App advertisement list 801.

Here, when the user having entered the promotion platform through game App 2 selects game App 1 on App advertisement list 801, details associated with a promotion and an advertisement, such as promotion information and compensation information 802 associated with game App 1 may be displayed at a lower end of App advertisement screen 800. For example, content saying “We will pay game money of the game App 1 if you install a program of game App 1 by MM DD, YYYY” may be displayed below App advertisement list 801. In addition, App advertisement list 801 may be displayed on the entire screen, and promotion information and compensation information 802 of the selected target App may be displayed as a popup window. That is, information may be displayed using a variety of methods.

Every time App advertisement list 801 including game App 1 is displayed for a user having entered the promotion platform, the service provider 330 may count the number of times (hereinafter, display counts) App advertisement list 801 is displayed. Here, when the number of users having entered the promotion platform reaches the display counts, service provider 330 may delete the promotion and the advertisement of game App 1 from App advertisement list 801. For example, the promotion and the advertisement of game App 1 may not be displayed through the promotion platform. When the service provider of game App 1 readjusts the display counts, service provider 330 may resume the promotion and the advertisement of game App 1.

For example, when a user enters the promotion platform after the service provider of game App 1 increases the display counts or after game App 1 satisfies the display counts as both the inventory App and the target App, service provider 330 may resume the promotion and the advertisement of game App 1 through the promotion platform.

As described above, service provider 330 may monitor game App 1 to display the promotion and the advertisement of game App 1 to a user registered to another game App. That is, service provider 330 may periodically monitor the number of users having entered the promotion platform through the game App 1 and the number of times the promotion and the advertisement of the game App 1 are displayed.

To advertise registered Apps to many users, service provider 330 may not provide a service provider of a corresponding App with compensation according to a duplicate entry of the same user in the promotion platform within a predetermined period, for example, one day, one week, one month, three months, and six months. For example, for a first entry of user 1 in a promotion platform during a day through game App 1, service provider 330 may increase the number of users of game App 1 and may not count user 1 with respect to a second or more (i.e., subsequent) entry of user 1 during the day. When the same user having entered the promotion platform on a previous day enters again the promotion platform on a following day or when another user of game App 1 enters the promotion platform, service provider 330 may count the corresponding user.

Referring to FIG. 8, when a user that has entered a promotion platform through game App 2 selects game App 1 by pressing down or double clicking game App 1 on App advertisement list 801, service provider 330 may display a promotion screen to the user to be capable of performing a promotion associated with game App 1. For example, service provider 330 may provide the user with a screen for downloading a screen of game App 1 and a moving picture associated with game App 1. When a user having entered the promotion platform through game App 2 performs a promotion such as installing a program of game App 1, game App 1 may provide the user with a compensation, for example, game money of game App 1, provided on the screen.

An example of displaying only target Apps on App advertisement list 801 on App advertisement screen 800 is described above with reference to FIG. 8. However, it is only an example and thus, contents associated with the target Apps may also be displayed, for example, together with the target Apps. For example, when a target App is a game App, game related contents such as a blog and a moving picture associated with a game may be displayed together with target game Apps.

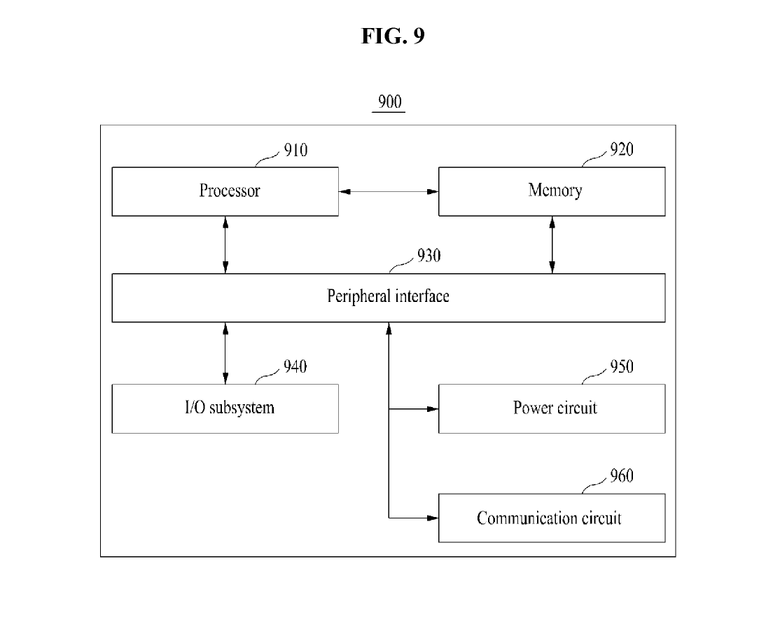

FIG. 9 is a block diagram illustrating an example of a configuration of computer system 900 according to one or more exemplary embodiments.

Referring to FIG. 9, computer system 900 may include at least one processor 910, memory 920, peripheral interface 930, I/O subsystem 940, power circuit 950, and communication circuit 960. Here, computer system 900 may correspond to a user terminal.

Memory 920 may include, for example, a high-speed random access memory (HSRAM), a magnetic disk, a static random access memory (SRAM), a dynamic RAM (DRAM), read only memory (ROM), a flash memory, and a non-volatile memory. Memory 920 may include a software module, an instruction set, or a variety of data required for an operation of computer system 900. Here, an access from another component such as processor 910 and peripheral interface 930 to memory 920 may be controlled by processor 910.

Peripheral interface 930 may couple an input device and/or output device of computer system 900 with processor 910 and memory 920. Processor 910 may perform a variety of functions for computer system 900 and process data by executing the software module or the instruction set stored in memory 920.

I/O subsystem 940 may couple various I/O peripheral devices with peripheral interface 930. For example, I/O subsystem 940 may include a controller for coupling peripheral interface 930 and a peripheral device such as a monitor, a keyboard, a mouse, a printer, and a touch screen or a sensor depending on a necessity. The I/O peripheral devices may be coupled with peripheral interface 930 without using I/O subsystem 940.

Power circuit 950 may supply a power to all of or a portion of components of a terminal. For example, power circuit 950 may include a power management system, at least one power source such as a battery and alternating circuit (AC), a charge system, a power failure detection circuit, a power converter or inverter, a power status indicator, or other components for creating, managing and distributing power.

Communication circuit 960 enables communication with another computer system using at least one external port. Alternatively, as described above, communication circuit 960 may enable communication with another computer system by including a radio frequency (RF) circuit and thereby transmitting and receiving an RF signal known as an electromagnetic signal, but aspects of the invention are not limited thereto.

FIG. 9 is an exemplary embodiment of computer system 900. Computer system 900 may have a configuration or an arrangement where components illustrated in FIG. 9 may be omitted, components not illustrated in FIG. 9 may be included, or two or more components are coupled differently from the illustration in FIG. 9. For example, a computer system for a communication terminal of a mobile environment may further include a touch screen, a sensor, and the like, in addition to the components of FIG. 9. A circuit for RF communication using a variety of communication methods, for example, wireless fidelity (Wi-Fi), 3^{rd} generation (3G), long term evolution (LTE), Bluetooth, near field communication (NFC), and ZigBee, may be included in communication circuit 960. Components includable in computer system 900 may be configured as hardware that includes an integrated circuit specified for at least one signal processing or application, software, or a combination of hardware and software. However, aspects of the invention are not limited thereto.

The methods according to exemplary embodiments may be configured in a program instruction form executable through various computer systems and thereby recorded in non-transitory computer-readable media.

As described above, a promotion platform providing method and system enable mobile Apps to share user traffic and to be advertised free of charge to a user of another App by using a promotion platform, and may provide compensation such as game money associated with a corresponding mobile App to a new user when the new user completes a mission associated with a promotion ongoing in the corresponding mobile App, thereby, inducing a user to continuously use the App. It is possible to attract users to continuously use the App that was advertised.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

While exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of providing a promotion platform, the method comprising:
registering mobile applications to a promotion platform system; and
providing a compensation corresponding to a user entry to a service provider of a first application in response to a user entering a promotion platform through a user interface of the first application,
wherein the user having entered the promotion platform receives, from a second application, the compensation in response to performing an operation designated in a promotion of the second application displayed by the promotion platform.

2. The method of claim 1, wherein the providing of the compensation corresponding to the user entry comprises:
displaying a promotion and an advertisement of the first application through the promotion platform.

3. The method of claim 2, wherein the providing of the compensation corresponding to the user entry comprises:
displaying the promotion and the advertisement of the first application to a user having entered the promotion platform among users of the mobile applications.

4. The method of claim 1, wherein the first application provides a compensation corresponding to the user entry in the promotion platform.

5. The method of claim 1, wherein the promotion platform shares user traffic of the registered applications.

6. The method of claim 1, wherein registration comprises providing a registration screen comprising at least one of compensation information to be provided from the first application to the user, a display icon, a promotion and an advertisement period of the first application, a promotion and an advertisement content, and a target country in which a promotion and an advertisement are to be displayed.

7. The method of claim 1, wherein the providing of the compensation corresponding to the user entry comprises:
monitoring the number of users having entered the promotion platform through the first application and the number of times a promotion and an advertisement of the first application are displayed; and
controlling the promotion and the advertisement of the first application to be displayed to the user based on the monitored number of users and number of times.

8. The method of claim 1, wherein the first application comprises a game application, and
the providing of the compensation corresponding to the user entry comprises displaying a promotion associated with a mission on the game application and compensation information s according to performing the mission through the promotion platform.

9. A non-transitory computer-readable storage medium having stored thereon processor executable instructions configured to perform a method comprising:
registering mobile applications to a promotion platform system; and
providing a compensation corresponding to a user entry to a service provider of a first application in response to a user entering a promotion platform through a user interface of the first application,
wherein the user having entered the promotion platform receives, from a second application, the compensation in response to performing an operation in a promotion of the second application displayed by the promotion platform.

10. A promotion platform system comprising:
an application register configured to register mobile applications on the promotion platform system; and
a service provider configured to provide a compensation corresponding to a user entry to a service provider of a first application in response to a user entering a promotion platform through a user interface provided from the first application,
wherein the user having entered the promotion platform through the user interface receives, from a second application, the compensation in response to performing an operation designated in a promotion of the second application displayed by the promotion platform.

11. The promotion platform system of claim 10, wherein the service provider is configured to display a promotion and an advertisement of the first application by the promotion platform.

12. The promotion platform system of claim 11, wherein the service provider is configured to display the promotion and the advertisement of the first application to at least one user having entered the promotion platform among users of the mobile applications.

13. The promotion platform system of claim 10, wherein the first application provides a compensation corresponding to the entry in the promotion platform to the user.

14. The promotion platform system of claim 10, wherein the promotion platform shares user traffic of the registered applications.

15. The promotion platform system of claim 10, wherein the service provider is configured to:
monitor the number of users having entered the promotion platform through the first application and the number of times a promotion and an advertisement of the first application are displayed, and
to control the promotion and the advertisement of the first application to be displayed to the user based on the monitored number of users and number of times.

16. The promotion platform system of claim 10, wherein the first application comprises a game application, and
the service provider is configured to display a promotion associated with a mission on the game application and compensation information in response to performing the mission through the promotion platform.

17. A promotion platform system comprising:
a memory to which a program is loaded; and
a processor,
wherein, according to a control of the program, the processor is configured to process:
a process of registering mobile applications; and
a process of providing a compensation corresponding to a user entry to a service provider of a first application in response to a user entering a promotion platform through a user interface provided from the first application,
wherein the user having entered the promotion platform through the user interface receives, from a second application, a compensation in response to performing an operation ii designated in a promotion of the second application displayed through the promotion platform.

18. A method of providing a promotion platform, the method comprising:
allowing a user of a first application to enter a promotion platform through the first application registered to the promotion platform;
displaying a target application to the user by the promotion platform;
providing a promotion of the target application in response to a user input; and
providing a compensation in response to the user performing an operation designated in the promotion,
wherein the promotion platform provides the compensation corresponding to the user entry in the promotion platform through a service provider of the first application.

19. The method of claim 18, wherein the promotion platform provides the user with a compensation designated by the first application to allow the user to enter the promotion platform.

20. The method of claim 18, wherein the first application is an inventory application to allow the user to enter the promotion platform, and
the target application shares user traffic of the inventory application by the promotion platform.
